(19) United States
(12) Patent Application Publication
(10) Pub. No.: US 2021/0086881 A1
(43) Pub. Date: Mar. 25, 2021

(54) PHONE CASE FOR DIVING AND IMPLEMENTATION METHOD THEREOF

(71) Applicant: Quanfu WANG, Jiangsu (CN)

(72) Inventor: Quanfu WANG, Jiangsu (CN)

(21) Appl. No.: 16/581,733

(22) Filed: Sep. 24, 2019

(51) Int. Cl. B63C 11/02; H04W 4/80; H04B 1/3888

(52) U.S. Cl. CPC B63C 11/02; H04W 4/80; A45C 11/00; B63C 2011/021; H04B 1/3888

(57) ABSTRACT

Disclosed is a phone case for diving comprising a housing including a rear housing rotatably connected to one side of front housing and sealingly connected to the other side, and a front housing. A surface of rear housing is connected with a photographing window on one side, and is further connected with an air suction assembly located on one side of photographing window and/or a light-filling assembly located on the other side of air suction assembly. The housing, connected with a function button, has a control module connected inside that is in signal connection with function button and light-filling assembly respectively and connected with phone by Bluetooth. Further disclosed is a method for implementing a phone case for diving, wherein air inside housing is extracted by air suction assembly, so that housing is vacuumed inside for good waterproof performance without steam appearing inside housing, making photographing effect better.

### BACKGROUND OF THE INVENTION

The present invention relates to the technical field of phone case, in particular, to a phone case for diving and an implementation method thereof.

Chinese Patent Application No. 201820733562.0 discloses a phone case with luminous waterproof function comprising a first case, a second case and a camera hole, wherein one side of the first case is movably connected with the second case, and the surface on one side of the first case is provided with an annular groove; an annular sealing ring is fixedly connected to one surface of the second case, and a bump rubber pad is fixedly connected to both ends of the first case and the second case; the other side of the first case is fixedly connected with a buckle, and one side of the second case is fixedly connected with a second buckle; a fluorescent sticker is fixedly connected to one side of the annular groove, and a glass lens is fixedly connected to the surface of the camera hole. In this present utility model, by embedding the sealing ring in the groove to place the phone in a sealed environment, the water can be effectively prevented from contacting the phone, so as to makes it easy for diving enthusiasts to shoot in the water, and a part of the light energy is absorbed by the fluorescent sticker, so that when the underwater light is not good, the lighting effect can be achieved to facilitate the operation of the phone.

There are still some problems in the above patents, such as: 1. The interior is not vacuumed, and the waterproof performance is poor; 2. The lighting cannot be provided, and the photographing performance is poor; 2. The air suction cannot be performed, and steam will appear inside; 3. There is no button connection, which is inconvenient for operation.

### BRIEF SUMMARY OF THE INVENTION

The object of the present invention is to provide a phone case for diving to solve the problems proposed in the background. The present invention provides a phone case for diving, which has the characteristics of good waterproof performance, good photographing performance and convenient operation.

Another object of the present invention is to provide a method for implementation of the phone case for diving.

To achieve above objects, the present invention provides the following technical solutions: a phone case for diving comprises a housing, the housing including a rear housing and a front housing, the rear housing being rotatably connected to one side of the front housing and being sealingly connected to the other side, one side of a surface of the rear housing being connected with a photographing window; the surface of the rear housing is further connected with an air suction assembly and/or a light-filling assembly; the air suction assembly is located on one side of the photographing window, and the light-filling assembly is located on the other side of the air suction assembly; the housing is connected with a function button, and an interior of the housing is connected with a control module, wherein the function button and the light-filling assembly are respectively signally connected to the control module, and the control module is connected with the phone by Bluetooth.

Further, in the present invention, the light-filling assembly includes a lamp holder, an LED board, a light-filling seal ring and a lamp head, wherein the lamp holder is connected to the rear housing, and the lamp holder is engagedly connected with the lamp head; an interior of the lamp head is connected with the LED board, and the light-filling seal ring is placed between the lamp head and the lamp holder, the LED board being signally connected to the control module.

Further, in the present invention, the air suction assembly includes an air suction rod, an air suction head, an air suction pipe, a sealing cap, an one-way air outlet valve, an air suction sealing ring and an end cap, wherein the air suction pipe is connected to the rear housing, and a lower end of the air suction pipe is communicated to an interior of the rear housing; the one-way air outlet valve is disposed where the air suction pipe is communicated to the rear housing, and its outer side is sealed by the sealing cap; an interior of the air suction pipe is slidably connected with the air suction rod, one end of the air suction rod located inside the air suction pipe is connected with the air suction head, and the other end of the air suction rod is connected with the end cap; the air suction sealing ring is disposed between the end cap and the air suction pipe; a fixing groove is disposed at one end of the air suction pipe connected with the end cap, and the end cap is connected with a fixing buckle matching the fixing groove.

Further, in the present invention, the surface of the rear housing is further connected with a sensor, and the sensor is located on one side of the air suction assembly; the sensor includes a sensor mounting seat, a sensor array and a protective cap, wherein the sensor mounting seat is connected on the rear housing, and an interior of the sensor mounting seat is connected with the sensor array; the sensor array includes a pressure sensor and a depth sensor, and the pressure sensor is located on one side of the depth sensor; an end of the sensor mounting seat is connected with the protective cap, and the sensor array is signally connected with the control module.

Further, in the present invention, the front housing is connected with a surface cap, and both the surface cap and the photographing window are transparent members; the rear housing is provided with a handle portion, and the handle portion is located on a side away from the photographing window; the function button includes a photographing button, the function button is connected on the front housing and located on one side of the surface cop; the photographing button is connected on the handle portion; one side of the rear housing is rotatably connected to one side of the front housing by a shaft, and the other side of the rear housing is sealingly connected to the other side of the front housing by a sealing knob.

Further, in the present invention, the control module includes a control chip, a switch circuit, a battery power detection circuit, an LED indicator, a function button circuit, a reset circuit, a program download port, a 3.3V voltage regulator circuit and a charge management circuit, wherein the switch circuit, the battery power detection circuit, the LED indicator, the function button circuit, the reset circuit, and the program download port are respectively connected to the control chip, and the depth sensor and the pressure sensor are also connected to the control chip; the 3.3V voltage regulator circuit is connected to the switch circuit and the depth sensor respectively, and the charge management circuit is connected to the switch circuit.

Further, in the present invention, the control chip includes a chip U3; a VDD terminal of the chip U3 is connected to a capacitor C18 and a capacitor C19, respectively; and the other ends of the capacitor C18 and the capacitor C19 are grounded; a 30th pin of the chip U3 is respectively connected to a capacitor C13 and a inductor L3, and the other end of the inductor L3 is connected with a capacitor C14 and an inductor L4, respectively; the other ends of the capacitor C13 and the capacitor C14 are grounded, and the other end of the inductor L4 is connected to an antenna E1; a 36th pin of the chip U3 is connected to a capacitor C11, and the other end of the capacitor C11 is grounded; the 35th pin of the chip U3 is connected to a capacitor C2, and the 34th pin of the chip U3 is connected to a capacitor C9; the other ends of the capacitor C2 and the capacitor C9 are grounded, and an oscillator X1 is connected between the connection ends where the capacitor C2 is connected to the chip U3 and the capacitor C9 is connected to the chip; the 33th pin of the chip U3 is connected to a capacitor C10, and the 32th pin of the chip U3 is connected to a capacitor C12; the other ends of the capacitor C10 and the capacitor C12 are grounded, and are also connected to the 31th pin of the chip U3; the 47th pin of the chip U3 is connected to an inductor L2, and the other end of the inductor L2 is connected to the inductor L1; the other end of the inductor L1 is respectively connected to a capacitor C1 and a 46th pin of the chip U3, and the other end of the capacitor C1 is grounded and connected to a 45th pin of the chip U3; a 48th pin of the chip U3 is connected to a capacitor C8, and the other end of the capacitor C8 is grounded; a DEC1 pin of the chip U3 is connected to a capacitor C7, and the other end of the capacitor C7 is connected to the capacitor C8.

Further, in the present invention, the switch circuit includes a triode Q1; an emitter and an base of the triode Q1 are respectively connected to the two ends of a resistor R5, and the base of the triode Q1 is also connected to a resistor R7; the other end of the resistor R7 is respectively connected to a collector of a triode Q2 and one end of a diode D3; an emitter of the triode Q2 is grounded, and a base of the triode Q2 is connected to a resistor R9; the other end of the resistor R9 is connected to a 0th pin of the chip U3, and the other end of a diode D3 is respectively connected to a button SW1 and a diode D4; the other end of the button SW1 is grounded, and the other end of the diode D4 is connected to a 1th pin of the chip U3; the battery power detection circuit includes a resistor R6, a resistor R8 and a capacitor C17, wherein one end of the resistor R6 is respectively connected to a resistor R8 and a 5th pin of the chip U3, the other end of the resistor R8 is grounded, and two ends of the resistor R8 are also connected to two ends of the capacitor C17; the LED indicator comprises a light-emitting diode D5, a light-emitting diode D6 and a light-emitting diode D7, wherein the light-emitting diode D5, the light-emitting diode D6 and the light-emitting diode D7 are connected to 6th, 7th and 8th pins of chip U3, respectively, the other ends of the light-emitting diode D5, the light-emitting diode D6 and the light-emitting diode D7 are respectively connected with a resistor R15, a resistor R16 and a resistor R19, and the other ends of the resistor R15, the resistor R16 and the resistor R19 are connected together; the function button circuit includes an interface TP1, an interface TP2, an interface TP3, an interface TP4, an interface TP5, an interface TP6, and a button SW2, wherein the interface TP1, the interface TP2, the interface TP3, the interface TP4, the interface TP5, the interface TP6, and the button SW2 are respectively connected to the 11th, 12th, 13th, 14th, 15th, 16th, and 17th pins of the chip U3, and correspondingly connected with a resistor R13, a resistor R20, a resistor R21, a resistor R22, a resistor R23, a resistor R24 and a resistor R25, the other ends of the resistor R13, the resistor R20, the resistor R21, the resistor R22, the resistor R23, the resistor R24 and the resistor R25 being connected together; the reset circuit includes a resistor R10 and a button SW3, wherein one end of the button SW3 is grounded, and the other end is connected to the 17th pin of the chip U3, one end of the button SW3 connected with the 17th pin of the chip U3 being connected with a resistor R10; the pressure sensor includes a chip U5, wherein a GND pin of the chip U5 is grounded, a VDD pin of the chip U5 is connected to a resistor R17 and a resistor R18, respectively, the other end of the resistor R17 is connected to a 2nd pin of the chip U5, the other end of the resistor R18 is connected to a 3rd pin of the chip U5, and the 2nd pin and the 3rd pin of the chip U5 are respectively connected to 20th and 19th pins of the chip U3; a 1st pin of the program download port is grounded, a 2nd pin of the program download port is connected with a 26th pin of the chip U3, a 3rd pin of the program download port is connected with a 25th pin of the chip U3, and a 4 pin of the program download port is connected to a 3.3V power supply; the depth sensor includes a chip U4, wherein a 3rd pin of the chip U4 is connected to a 43rd pin of the chip U3, a 2nd pin of the chip U4 is grounded, a resistor R14 is connected between the 3rd pin of the chip U4 and the 2nd pin of the chip U4, a 1st pin of the chip U4 is connected to a 42th pin of the chip U3, the 1st pin of the chip U4 is connected with a resistor R11, a SDI pin of the chip U4 is connected to a 40th pin of the chip U3, a SDO pin of the chip U4 is connected to a 41th pin of the chip U3, and a resistor R12 is connected between a VDD pin of the chip U4 and a SDI pin of the chip U4; the 3.3V voltage regulator circuit includes a chip U2, wherein a 5th pin of the chip U2 is respectively connected to the VDD pin and a PS pin of the chip U4, the 5th pin of the chip U2 is also connected to a capacitor C15, the other end of the capacitor C15 is grounded, a VIN pin and a CE pin of the chip U2 are respectively connected to a capacitor C16, the other end of the capacitor C16 and a GND end of the chip U2 are grounded, and one end of the capacitor C16 connected to the chip U2 is also connected to the collector of the transistor Q1; the charge management circuit includes a chip U1, wherein 5th and 3rd pins of the chip U1 are respectively connected to two ends of a capacitor C5 and a capacitor C6, two ends of the capacitor C6 are also connected to a header P1, a 5th pin of the chip U1 is also connected to an emitter of the triode Q1, a 2nd pin of the chip U1 is connected to a resistor R4, the other end of the resistor R4 and a 1st pin of the chip U1 are grounded respectively, a GHRG pin and a STDBY pin of the chip U1 are respectively connected to a light-emitting diode D1 and a light-emitting diode D2, and the other ends of the light-emitting diode D1 and the light-emitting diode D2 are respectively connected with a resistor R2 and a resistor R3; the other ends of the resistor R2 and the resistor R3 are connected together, and then connected to a VCC pin and a CE pin of the chip U1, respectively; one end of a capacitor C3 and one end of a capacitor C4 are grounded, and the other ends thereof is connected to the resistor R2 and the resistor R3; the ends of the resistor R2 connected together with the resistor R3 is further connected with a resistor R1.

Further, in the present invention, the method for implementing a phone case for diving comprises steps of:

(I) opening the front housing and the rear housing;

(II) turning on the phone Bluetooth for connecting with the control module via the Bluetooth, placing the phone therein, and a display screen of the phone facing the front housing;

(III) closing the front housing and the rear housing, and tightening by the sealing knob;

(IV) rotating the end cap to separate the fixing buckle from the fixing groove, then pushing and pulling the end cap to extract the air inside the housing;

(V) fixing the end cap to the fixing groove through the fixing buckle after extracting the air, then performing operations by the function button.

Further, in the present invention, the method for implementing a phone case for diving, the light-filling assembly includes a lamp holder, an LED board, a light-filling seal ring and a lamp head, wherein the lamp holder is connected to the rear housing, and the lamp holder is engagedly connected with the lamp head; an interior of the lamp head is connected with the LED board, and the light-filling seal ring is placed between the lamp head and the lamp holder, the LED board being signally connected to the control module; the air suction assembly includes an air suction rod, an air suction head, an air suction pipe, a sealing cap, an one-way air outlet valve, an air suction sealing ring and an end cap, wherein the air suction pipe is connected to the rear housing, and a lower end of the air suction pipe is communicated to an interior of the rear housing; the one-way air outlet valve is disposed where the air suction pipe is communicated to the rear housing, and its outer side is sealed by the sealing cap; an interior of the air suction pipe is slidably connected with the air suction rod, one end of the air suction rod located inside the air suction pipe is connected with the air suction head, and the other end of the air suction rod is connected with the end cap; the air suction sealing ring is disposed between the end cap and the air suction pipe; a fixing groove is disposed at one end of the air suction pipe connected with the end cap, and the end cap is connected with a fixing buckle matching the fixing groove; the surface of the rear housing is further connected with a sensor, and the sensor is located on one side of the air suction assembly; the sensor includes a sensor mounting seat, a sensor array and a protective cap, wherein the sensor mounting seat is connected on the rear housing, and an interior of the sensor mounting seat is connected with the sensor array; the sensor array includes a pressure sensor and a depth sensor, and the pressure sensor is located on one side of the depth sensor; an end of the sensor mounting seat is connected with the protective cap, and the sensor array is signally connected with the control module; the front housing is connected with a surface cap, and both the surface cap and the photographing window are transparent members; the rear housing is provided with a handle portion, and the handle portion is located on a side away from the photographing window; the function button includes a photographing button, the function button is connected on the front housing and located on one side of the surface cop; the photographing button is connected on the handle portion; one side of the rear housing is rotatably connected to one side of the front housing by a shaft, and the other side of the rear housing is sealingly connected to the other side of the front housing by a sealing knob; the control module includes a control chip, a switch circuit, a battery power detection circuit, an LED indicator, a function button circuit, a reset circuit, a program download port, a 3.3V voltage regulator circuit and a charge management circuit, wherein the switch circuit, the battery power detection circuit, the LED indicator, the function button circuit, the reset circuit, and the program download port are respectively connected to the control chip, and the depth sensor and the pressure sensor are also connected to the control chip; the 3.3V voltage regulator circuit is connected to the switch circuit and the depth sensor respectively, and the charge management circuit is connected to the switch circuit; the control chip includes a chip U3; a VDD terminal of the chip U3 is connected to a capacitor C18 and a capacitor C19, respectively; and the other ends of the capacitor C18 and the capacitor C19 are grounded; a 30th pin of the chip U3 is respectively connected to a capacitor C13 and a inductor L3, and the other end of the inductor L3 is connected with a capacitor C14 and an inductor L4, respectively; the other ends of the capacitor C13 and the capacitor C14 are grounded, and the other end of the inductor L4 is connected to an antenna E1; a 36th pin of the chip U3 is connected to a capacitor C11, and the other end of the capacitor C11 is grounded; the 35th pin of the chip U3 is connected to a capacitor C2, and the 34th pin of the chip U3 is connected to a capacitor C9; the other ends of the capacitor C2 and the capacitor C9 are grounded, and an oscillator X1 is connected between the connection ends where the capacitor C2 is connected to the chip U3 and the capacitor C9 is connected to the chip; the 33th pin of the chip U3 is connected to a capacitor C10, and the 32th pin of the chip U3 is connected to a capacitor C12; the other ends of the capacitor C10 and the capacitor C12 are grounded, and are also connected to the 31th pin of the chip U3; the 47th pin of the chip U3 is connected to an inductor L2, and the other end of the inductor L2 is connected to the inductor L1; the other end of the inductor L1 is respectively connected to a capacitor C1 and a 46th pin of the chip U3, and the other end of the capacitor C1 is grounded and connected to a 45th pin of the chip U3; a 48th pin of the chip U3 is connected to a capacitor C8, and the other end of the capacitor C8 is grounded; a DEC1 pin of the chip U3 is connected to a capacitor C7, and the other end of the capacitor C7 is connected to the capacitor C8; the switch circuit includes a triode Q1; an emitter and an base of the triode Q1 are respectively connected to the two ends of a resistor R5, and the base of the triode Q1 is also connected to a resistor R7; the other end of the resistor R7 is respectively connected to a collector of a triode Q2 and one end of a diode D3; an emitter of the triode Q2 is grounded, and a base of the triode Q2 is connected to a resistor R9; the other end of the resistor R9 is connected to a 0th pin of the chip U3, and the other end of a diode D3 is respectively connected to a button SW1 and a diode D4; the other end of the button SW1 is grounded, and the other end of the diode D4 is connected to a 1th pin of the chip U3; the battery power detection circuit includes a resistor R6, a resistor R8 and a capacitor C17, wherein one end of the resistor R6 is respectively connected to a resistor R8 and a 5th pin of the chip U3, the other end of the resistor R8 is grounded, and two ends of the resistor R8 are also connected to two ends of the capacitor C17; the LED indicator comprises a light-emitting diode D5, a light-emitting diode D6 and a light-emitting diode D7, wherein the light-emitting diode D5, the light-emitting diode D6 and the light-emitting diode D7 are connected to 6th, 7th and 8th pins of chip U3, respectively, the other ends of the light-emitting diode D5, the light-emitting diode D6 and the light-emitting diode D7 are respectively connected with a resistor R15, a resistor R16 and a resistor R19, and the other ends of the resistor R15, the resistor R16 and the resistor R19 are connected together; the function button circuit includes an interface TP1, an interface TP2, an interface TP3, an interface TP4, an interface TP5, an interface TP6, and a button SW2, wherein the interface TP1, the interface TP2, the interface TP3, the interface TP4, the interface TP5, the interface TP6, and the button SW2 are respectively connected to the 11th, 12th, 13th, 14th, 15th, 16th, and 17th pins of the chip U3, and correspondingly connected with a resistor R13, a resistor R20, a resistor R21, a resistor R22, a resistor R23, a resistor R24 and a resistor R25, the other ends of the resistor R13, the resistor R20, the resistor R21, the resistor R22, the resistor R23, the resistor R24 and the resistor R25 being connected together; the reset circuit includes a resistor R10 and a button SW3, wherein one end of the button SW3 is grounded, and the other end is connected to the 17th pin of the chip U3, one end of the button SW3 connected with the 17th pin of the chip U3 being connected with a resistor R10; the pressure sensor includes a chip U5, wherein a GND pin of the chip U5 is grounded, a VDD pin of the chip U5 is connected to a resistor R17 and a resistor R18, respectively, the other end of the resistor R17 is connected to a 2nd pin of the chip U5, the other end of the resistor R18 is connected to a 3rd pin of the chip U5, and the 2nd pin and the 3rd pin of the chip U5 are respectively connected to 20th and 19th pins of the chip U3; a 1st pin of the program download port is grounded, a 2nd pin of the program download port is connected with a 26th pin of the chip U3, a 3rd pin of the program download port is connected with a 25th pin of the chip U3, and a 4 pin of the program download port is connected to a 3.3V power supply; the depth sensor includes a chip U4, wherein a 3rd pin of the chip U4 is connected to a 43rd pin of the chip U3, a 2nd pin of the chip U4 is grounded, a resistor R14 is connected between the 3rd pin of the chip U4 and the 2nd pin of the chip U4, a 1st pin of the chip U4 is connected to a 42th pin of the chip U3, the 1st pin of the chip U4 is connected with a resistor R11, a SDI pin of the chip U4 is connected to a 40th pin of the chip U3, a SDO pin of the chip U4 is connected to a 41th pin of the chip U3, and a resistor R12 is connected between a VDD pin of the chip U4 and a SDI pin of the chip U4; the 3.3V voltage regulator circuit includes a chip U2, wherein a 5th pin of the chip U2 is respectively connected to the VDD pin and a PS pin of the chip U4, the 5th pin of the chip U2 is also connected to a capacitor C15, the other end of the capacitor C15 is grounded, a VIN pin and a CE pin of the chip U2 are respectively connected to a capacitor C16, the other end of the capacitor C16 and a GND end of the chip U2 are grounded, and one end of the capacitor C16 connected to the chip U2 is also connected to the collector of the transistor Q1; the charge management circuit includes a chip U1, wherein 5th and 3rd pins of the chip U1 are respectively connected to two ends of a capacitor C5 and a capacitor C6, two ends of the capacitor C6 are also connected to a header P1, a 5th pin of the chip U1 is also connected to an emitter of the triode Q1, a 2nd pin of the chip U1 is connected to a resistor R4, the other end of the resistor R4 and a 1st pin of the chip U1 are grounded respectively, a GHRG pin and a STDBY pin of the chip U1 are respectively connected to a light-emitting diode D1 and a light-emitting diode D2, and the other ends of the light-emitting diode D1 and the light-emitting diode D2 are respectively connected with a resistor R2 and a resistor R3; the other ends of the resistor R2 and the resistor R3 are connected together, and then connected to a VCC pin and a CE pin of the chip U1, respectively; one end of a capacitor C3 and one end of a capacitor C4 are grounded, and the other ends thereof is connected to the resistor R2 and the resistor R3; the ends of the resistor R2 connected together with the resistor R3 is further connected with a resistor R1.

Further, in the present invention, the method for implementing a phone case for diving is to be supplemented.

Compared with the prior art, the present invention has the following beneficial effects:

1. In the present invention, an air inside the housing is taken out by the air suction assembly, so that the interior of the housing is vacuumed and the waterproof performance is good, and no steam will appear inside the housing so as to make the photographing effect better;

2. The present invention is provided with a function button and a photographing button, and is connected with the phone through Bluetooth, so as to facilitate the use;

3. The present invention is provided with a light-filling assembly, so that the light may be provided when taking pictures to make the photographing effect better;

4. The present invention is provided with a handle portion, and the photographing button is arranged on the handle portion, so as to make the present invention more convenient to use.

### BRIEF DESCRIPTION OF THE DRAWINGS

FIG. 1 is a view of the structure of the present invention;

FIG. 2 is a rear view of the structure of FIG. 1 in the present invention;

FIG. 3 is an exploded view of the structure of FIG. 1 in the present invention;

FIG. 4 is a structural view of a light-filling assembly in FIG. 1 of the present invention;

FIG. 5 is a structural view of a sensor in FIG. 1 of the present invention;

FIG. 6 is a structural view of an air suction assembly in FIG. 1 of the present invention;

FIG. 7 is an exploded view of the structure of the overall present invention;

FIG. 8 is a system block view of a control module of the present invention;

FIG. 9 is a view of a circuit structure of a control module of the present invention;

FIG. 10 is a view of a circuit structure of a control chip of the present invention;

FIG. 11 is a view of the structure of a charge management circuit of the present invention;

FIG. 12 is a view of the structure of a switch circuit of the present invention;

FIG. 13 is a view of the structure of a 3.3V voltage regulator circuit of the present invention;

FIG. 14 is a view of the structure of a battery power detection circuit of the present invention;

FIG. 15 is a view of the structure of a function button circuit of the present invention;

FIG. 16 is a structural view of a depth sensor circuit of the present invention;

FIG. 17 is a view of the structure of a program download port circuit of the present invention;

FIG. 18 is a structural view of a pressure sensor circuit of the present invention;

FIG. 19 is a view of the structure of a reset circuit of the present invention;

FIG. 20 is a view of the structure of an LED indicator circuit of the present invention;

FIG. 21 is a view of the structure of a sealing knob of the present invention.

FIG. 22 is an enlarge view for the part A of FIG. 9.

FIG. 23 is an enlarge view for the part B of FIG. 9.

FIG. 24 is an enlarge view for the part C of FIG. 9.

FIG. 25 is an enlarge view for the part D of FIG. 9.

FIG. 26 is an enlarge view for the part E of FIG. 9.

FIG. 27 is an enlarge view for the part F of FIG. 9.

FIG. 28 is an enlarge view for the part G of FIG. 9.

FIG. 29 is an enlarge view for the part H of FIG. 9.

FIG. 30 is an enlarge view for the part I of FIG. 9.

In figures: 1 housing; 2 rear housing; 3 front housing; 4 light-filling assembly; 41 lamp holder; 42 LED board; 43 light-filling sealing ring; 44 lamp head; 5 air suction assembly; 51 fixing buckle; 52 air suction rod; 53 air suction head; 54 air suction pipe; 55 sealing cap; 56 one-way air outlet valve; 57 fixing groove; 58 air suction sealing ring; 59 end cap; 6 sensor; 61 sensor mounting seat; 62 sensor array; 63 protective cap; 7 surface cap; 8 function button; 9 sealing knob; 10 shaft; 11 photographing window; 12 photographing button; 13 power supply; 14 handle portion; 15 PCB board.

### DETAILED DESCRIPTION OF THE INVENTION

The technical solutions in the embodiments of the present invention will be clearly and completely described hereafter in connection with the drawings in the embodiments of the present invention. It is apparent that the described embodiments are only a part of the embodiments of the present invention, but not the whole. Based on the embodiments of the present invention, all the other embodiments obtained by those of ordinary skill in the art without inventive effort are within the scope of the present invention.

### Embodiment 1

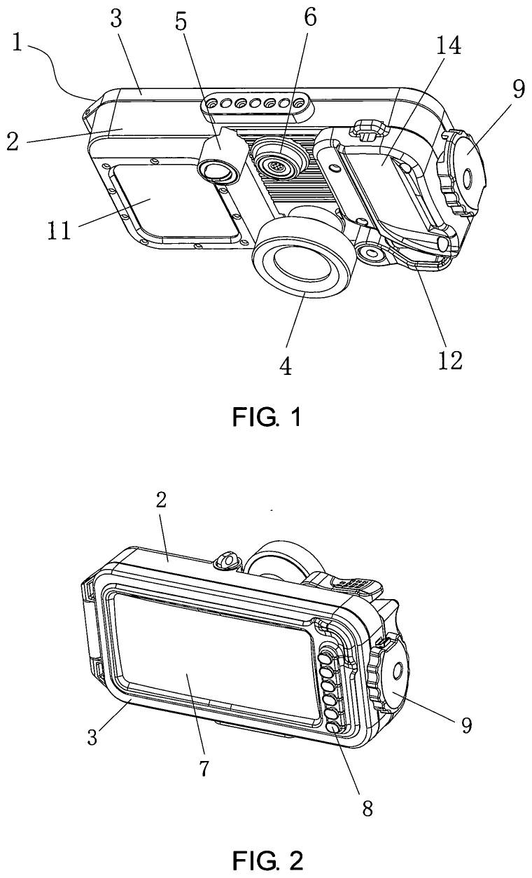

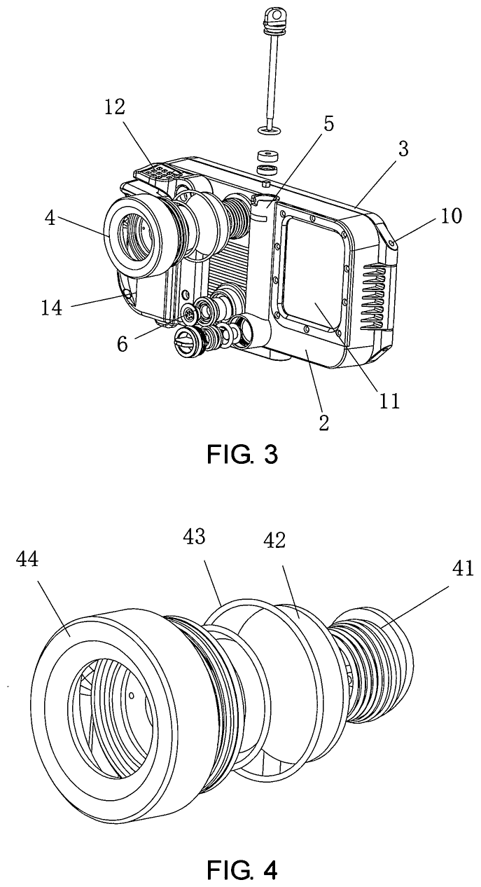

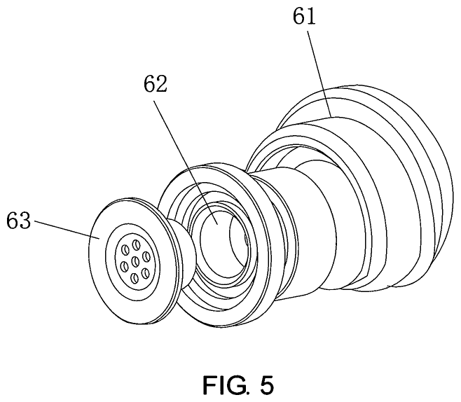

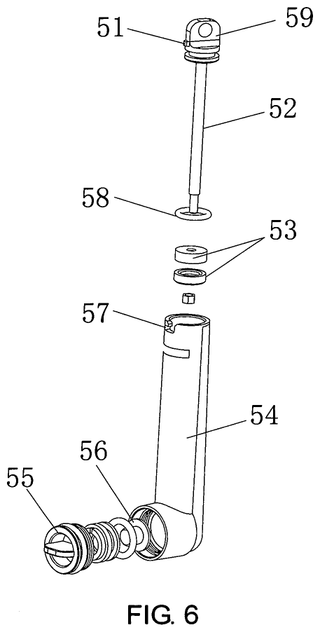

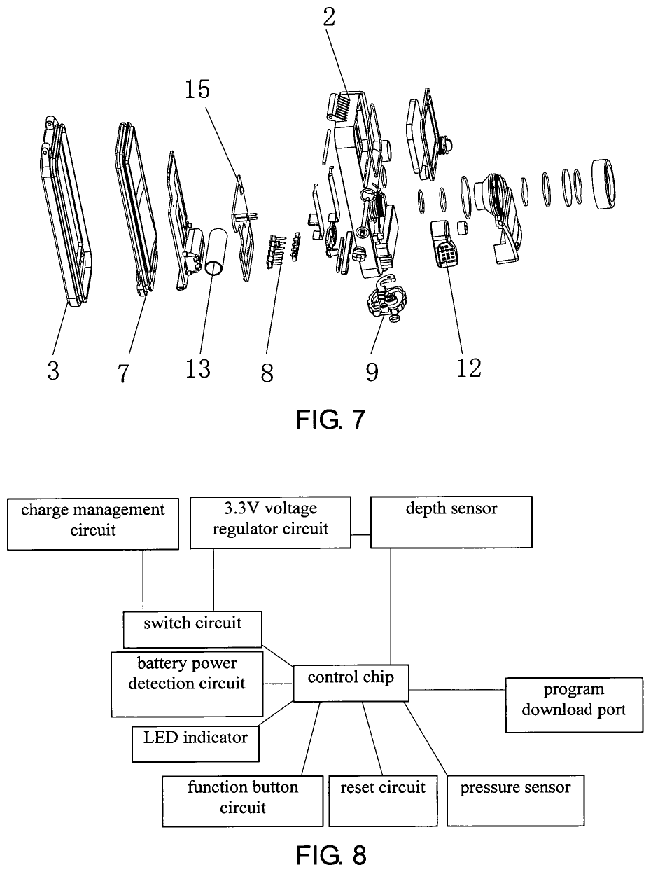

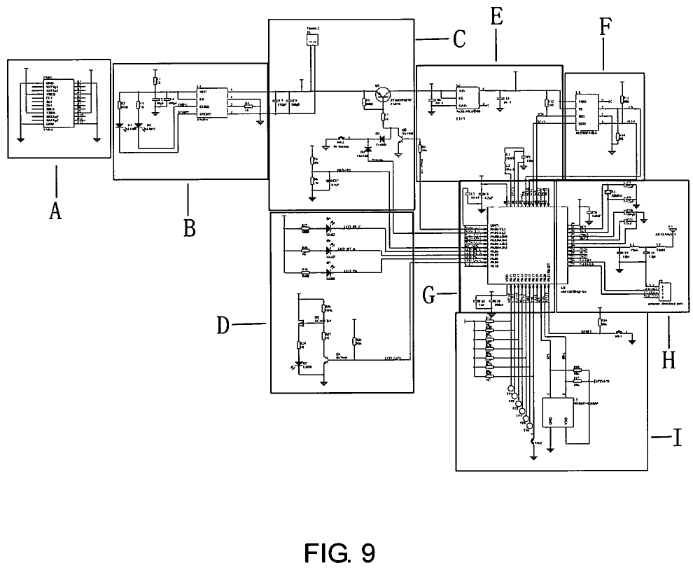

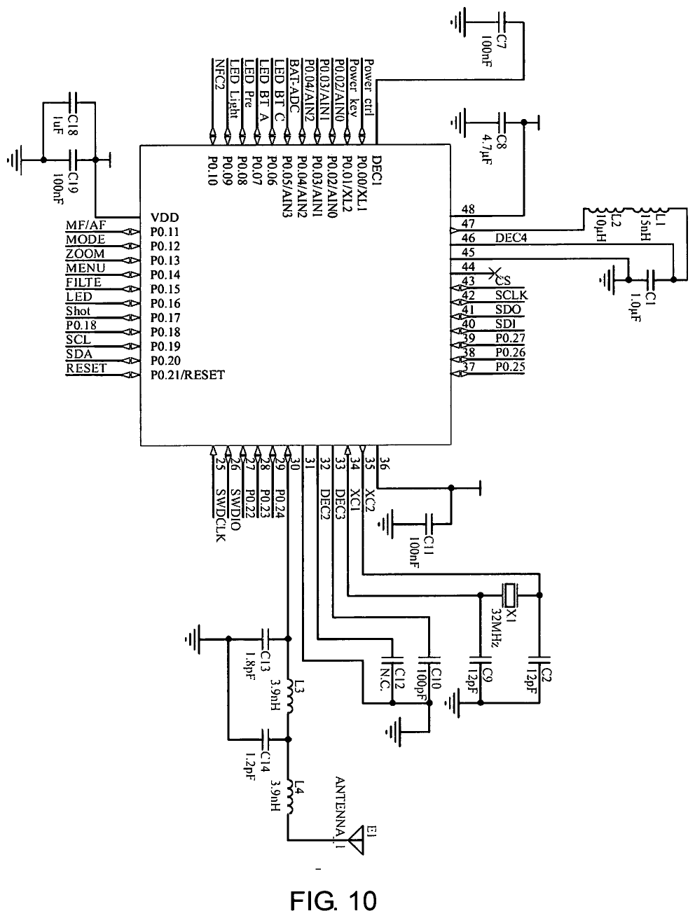

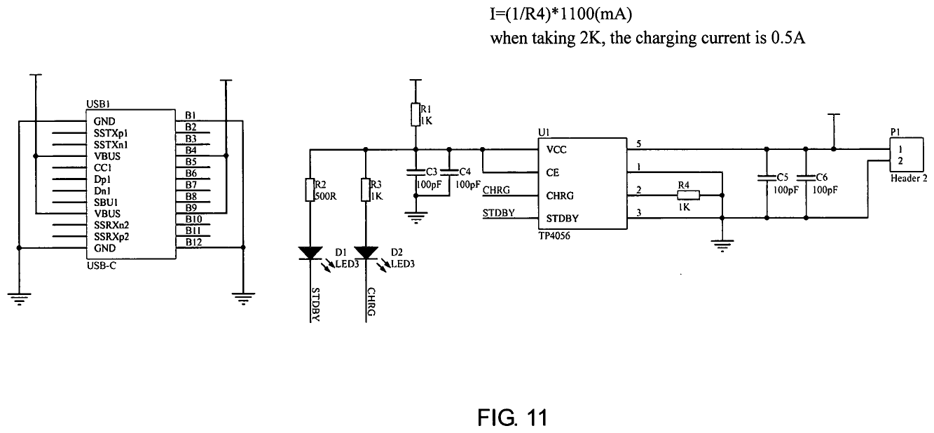

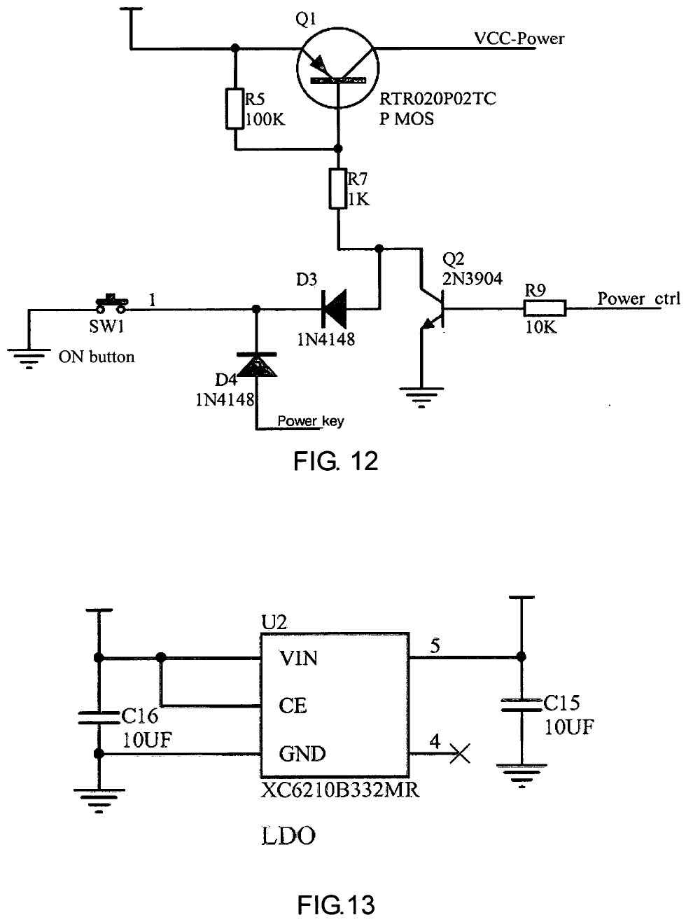

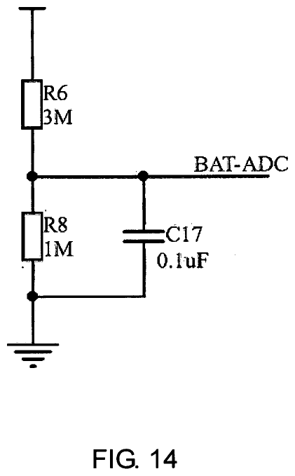

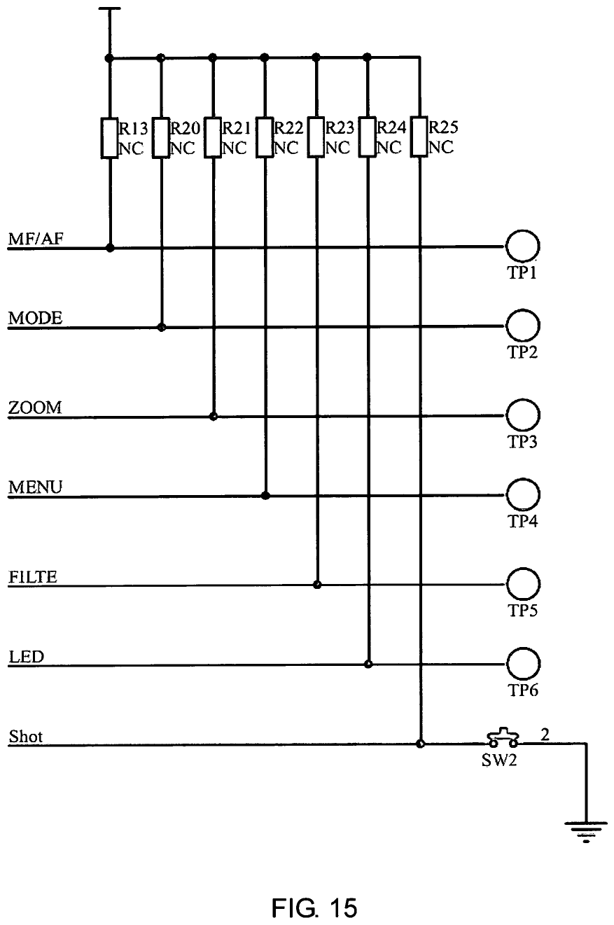

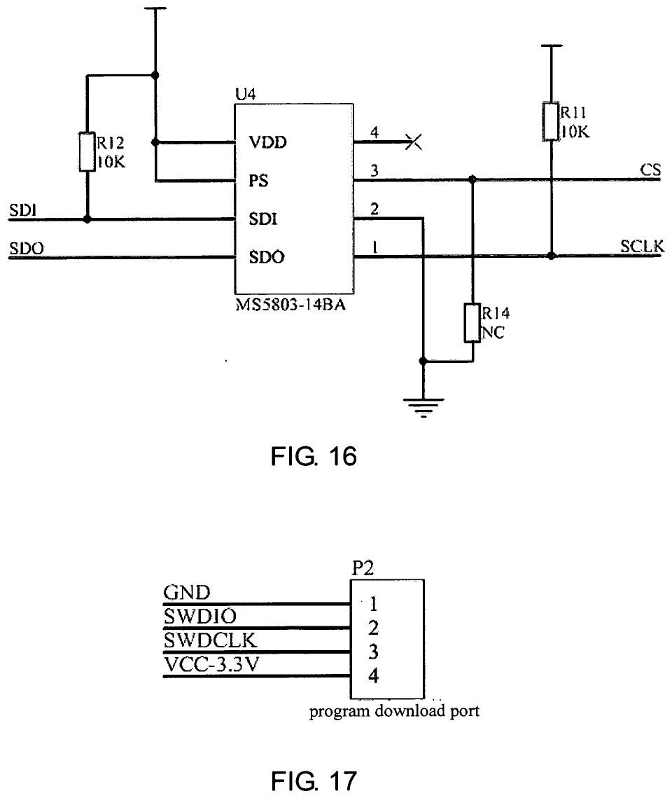

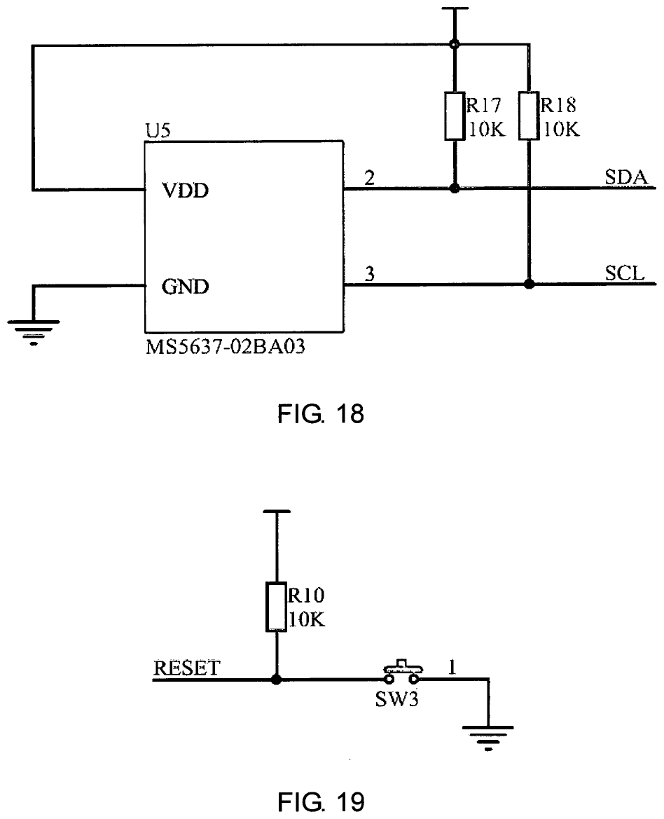

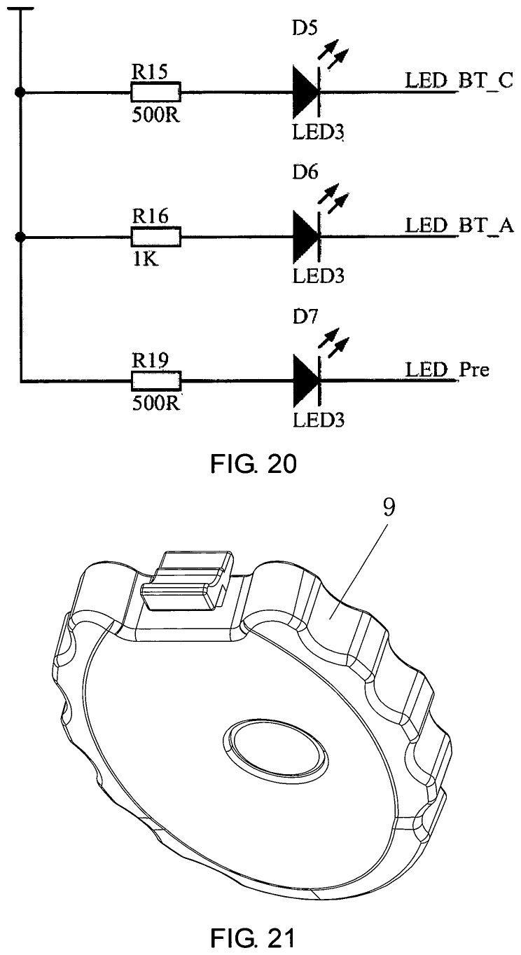

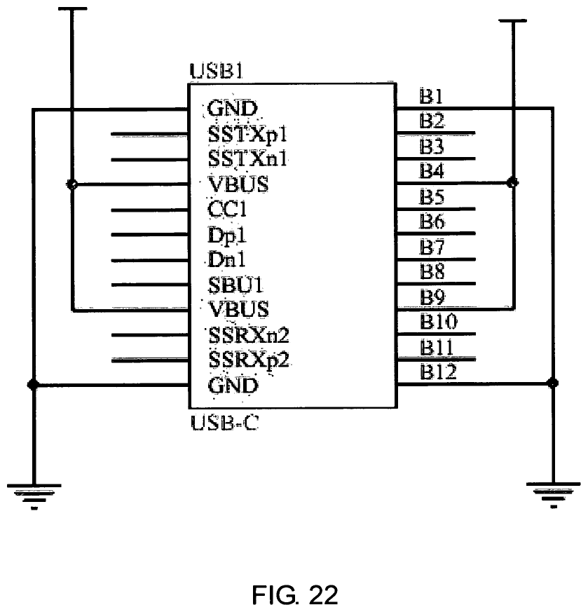

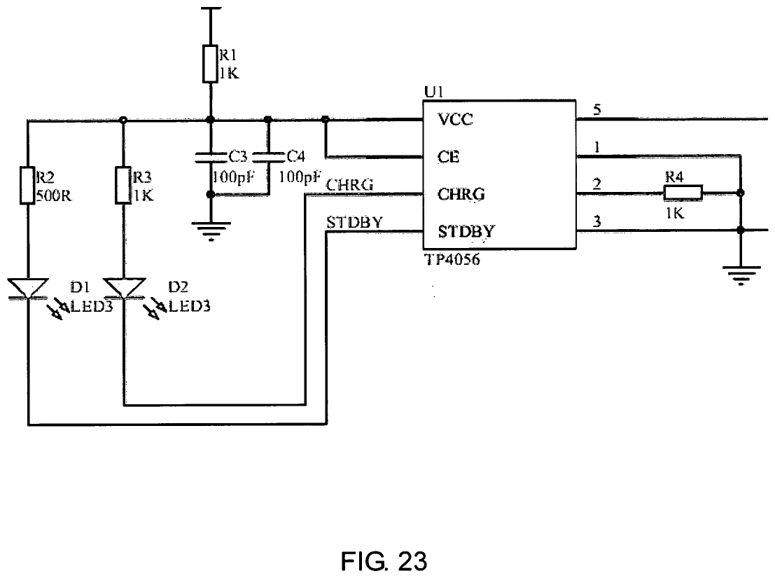

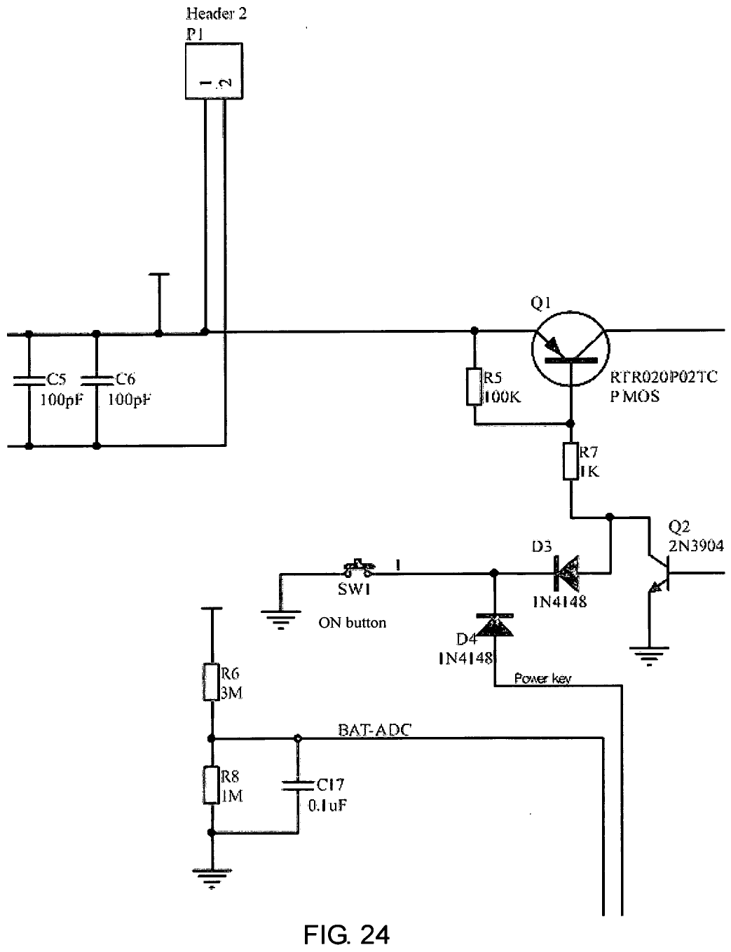

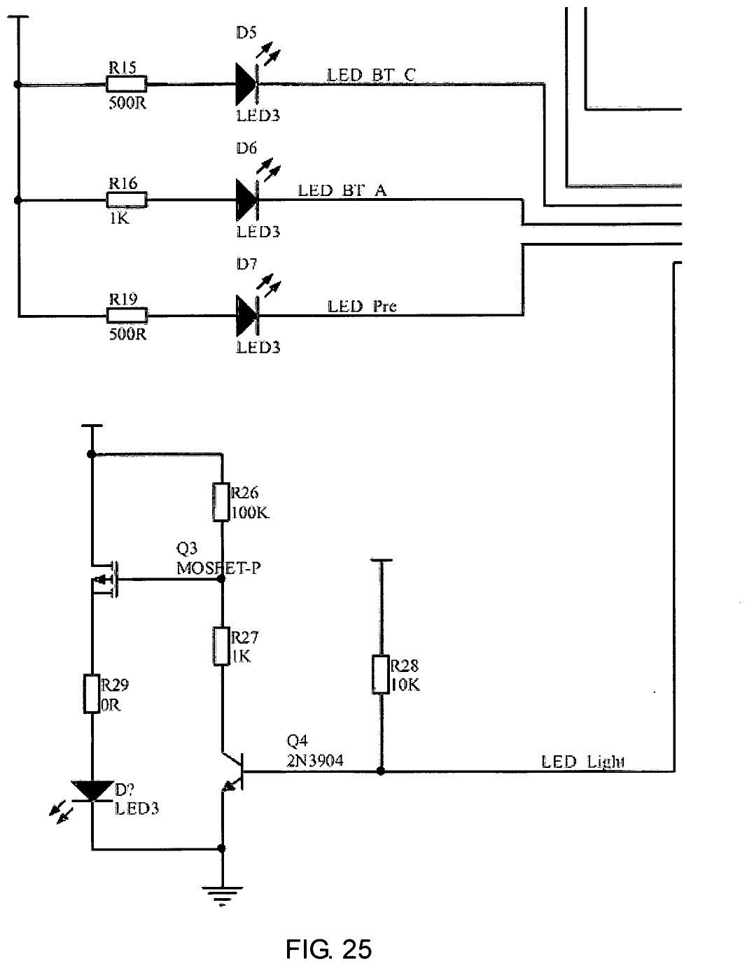

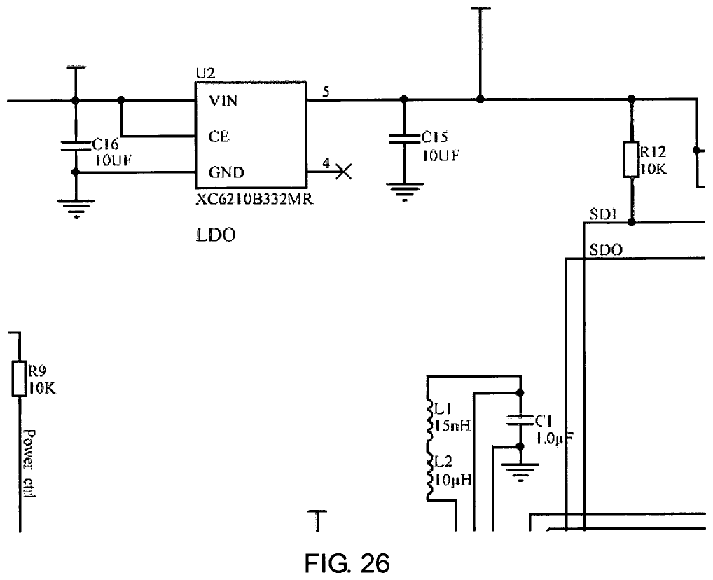

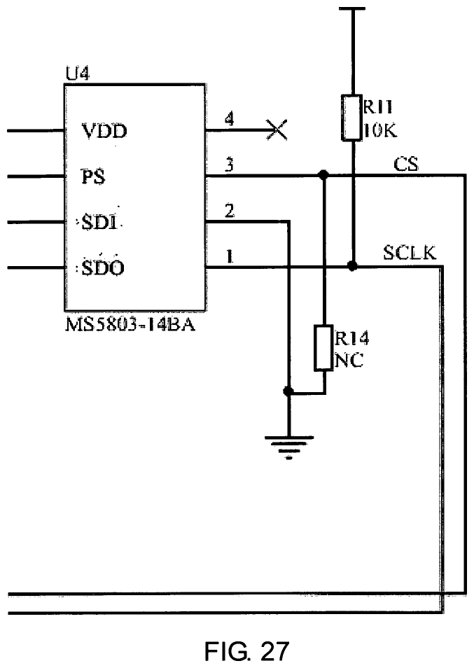

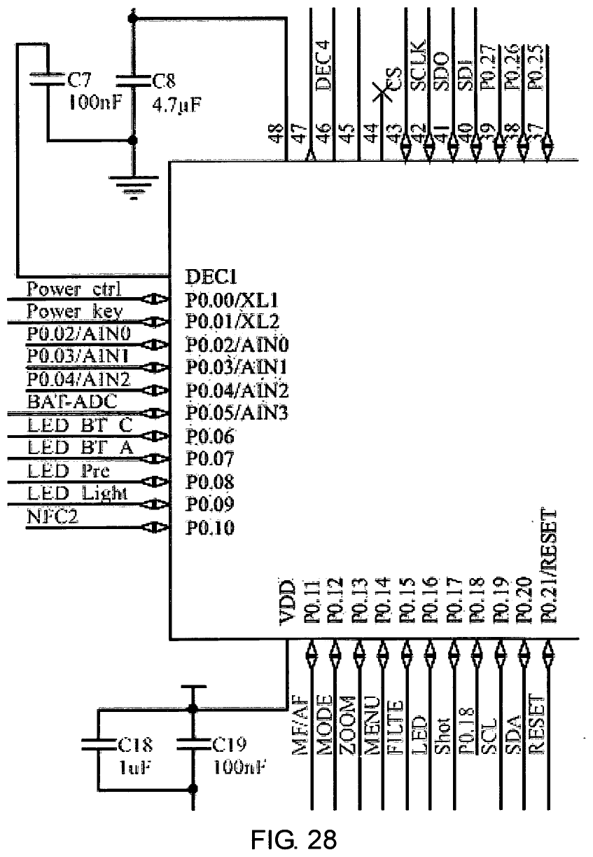

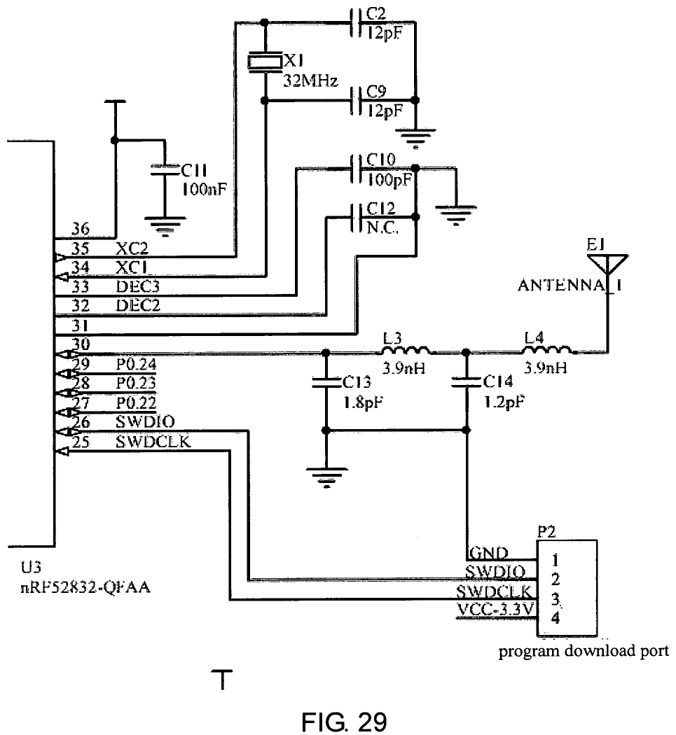

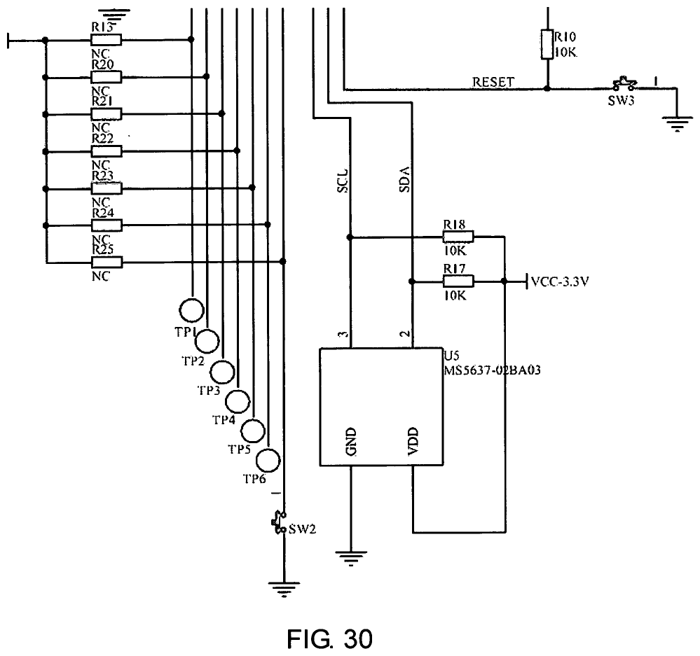

With reference to FIGS. 1 to 21 the present invention provides the following technical solutions: a phone case for diving, comprising a housing 1, the housing 1 including a rear housing 2 and a front housing 3, the rear housing 2 being rotatably connected to one side of the front housing 3 and being sealingly connected to the other side, one side of a surface of the rear housing 2 being connected with a photographing window 11; the surface of the rear housing 2 is further connected with an air suction assembly 5; the air suction assembly 5 is located on one side of the photographing window 11, the housing 1 is connected with a function button 8, and an interior of the housing 1 is connected with a PCB board 15; the PCB board 15 is connected to a position corresponding to a handle portion 14, a control module is integrated on the PCB board 15, and a power supply 13 is also connected to a position of the interior of the housing 1 corresponding to the handle portion 14; the power supply 13 is connected to the control module by telecommunications, the function button 8 and the light-filling assembly 4 are respectively signally connected with the control module, and the control module is connected with the phone by Bluetooth.

Further, the air suction assembly 5 includes an air suction rod 52, an air suction head 53, an air suction pipe 54, a sealing cap 55, an one-way air outlet valve 56, an air suction sealing ring 58 and an end cap 59, wherein the air suction pipe 54 is connected to the rear housing 2, and a lower end of the air suction pipe 54 is communicated to an interior of the rear housing 2; the one-way air outlet valve 56 is disposed where the air suction pipe 54 is communicated to the rear housing 2, and its outer side is sealed by the sealing cap 55; an interior of the air suction pipe 54 is slidably connected with the air suction rod 52, one end of the air suction rod 52 located inside the air suction pipe 54 is connected with the air suction head 53, and the other end of the air suction rod 52 is connected with the end cap 59; the air suction sealing ring 58 is disposed between the end cap 59 and the air suction pipe 54; a fixing groove 57 is disposed at one end of the air suction pipe 54 connected with the end cap 59, and the end cap 59 is connected with a fixing buckle 51 matching the fixing groove 57.

Further, the surface of the rear housing 2 is further connected with a sensor 6, and the sensor 6 is located on one side of the air suction assembly 5; the sensor 6 includes a sensor mounting seat 61, a sensor array 62 and a protective cap 63, wherein the sensor mounting seat 61 is connected on the rear housing 2, and an interior of the sensor mounting seat 61 is connected with the sensor array 62; the sensor array 62 includes a pressure sensor and a depth sensor, and the pressure sensor is located on one side of the depth sensor; an end of the sensor mounting seat 61 is connected with the protective cap 63, and the sensor array 62 is signally connected with the control module.

Further, the front housing 3 is connected with a surface cap 7, and both the surface cap 7 and the photographing window 11 are transparent members; the rear housing 2 is provided with a handle portion 14, and the handle portion 14 is located on a side away from the photographing window 11; the function button 8 includes a photographing button 12, the function button 8 is connected on the front housing 3 and located on one side of the surface cop 7; the photographing button 12 is connected on the handle portion 14; one side of the rear housing 2 is rotatably connected to one side of the front housing 3 by a shaft 10, and the other side of the rear housing is sealingly connected to the other side of the front housing by a sealing knob 9.

Further, the control module includes a control chip, a switch circuit, a battery power detection circuit, an LED indicator, a function button circuit, a reset circuit, a program download port, a 3.3V voltage regulator circuit and a charge management circuit, wherein the switch circuit, the battery power detection circuit, the LED indicator, the function button circuit, the reset circuit, and the program download port are respectively connected to the control chip, and the depth sensor and the pressure sensor are also connected to the control chip; the 3.3V voltage regulator circuit is connected to the switch circuit and the depth sensor respectively, and the charge management circuit is connected to the switch circuit.

Further, the control chip includes a chip U3; a VDD terminal of the chip U3 is connected to a capacitor C18 and a capacitor C19, respectively; and the other ends of the capacitor C18 and the capacitor C19 are grounded; a 30th pin of the chip U3 is respectively connected to a capacitor C13 and a inductor L3, and the other end of the inductor L3 is connected with a capacitor C14 and an inductor L4, respectively; the other ends of the capacitor C13 and the capacitor C14 are grounded, and the other end of the inductor L4 is connected to an antenna E1; a 36th pin of the chip U3 is connected to a capacitor C11, and the other end of the capacitor C11 is grounded; the 35th pin of the chip U3 is connected to a capacitor C2, and the 34th pin of the chip U3 is connected to a capacitor C9; the other ends of the capacitor C2 and the capacitor C9 are grounded, and an oscillator X1 is connected between the connection ends where the capacitor C2 is connected to the chip U3 and the capacitor C9 is connected to the chip; the 33th pin of the chip U3 is connected to a capacitor C10, and the 32th pin of the chip U3 is connected to a capacitor C12; the other ends of the capacitor C10 and the capacitor C12 are grounded, and are also connected to the 31th pin of the chip U3; the 47th pin of the chip U3 is connected to an inductor L2, and the other end of the inductor L2 is connected to the inductor L1; the other end of the inductor L1 is respectively connected to a capacitor C1 and a 46th pin of the chip U3, and the other end of the capacitor C1 is grounded and connected to a 45th pin of the chip U3; a 48th pin of the chip U3 is connected to a capacitor C8, and the other end of the capacitor C8 is grounded; a DEC1 pin of the chip U3 is connected to a capacitor C7, and the other end of the capacitor C7 is connected to the capacitor C8.

Further, the switch circuit includes a triode Q1; an emitter and an base of the triode Q1 are respectively connected to the two ends of a resistor R5, and the base of the triode Q1 is also connected to a resistor R7; the other end of the resistor R7 is respectively connected to a collector of a triode Q2 and one end of a diode D3; an emitter of the triode Q2 is grounded, and a base of the triode Q2 is connected to a resistor R9; the other end of the resistor R9 is connected to a 0th pin of the chip U3, and the other end of a diode D3 is respectively connected to a button SW1 and a diode D4; the other end of the button SW1 is grounded, and the other end of the diode D4 is connected to a 1th pin of the chip U3; the battery power detection circuit includes a resistor R6, a resistor R8 and a capacitor C17, wherein one end of the resistor R6 is respectively connected to a resistor R8 and a 5th pin of the chip U3, the other end of the resistor R8 is grounded, and two ends of the resistor R8 are also connected to two ends of the capacitor C17; the LED indicator comprises a light-emitting diode D5, a light-emitting diode D6 and a light-emitting diode D7, wherein the light-emitting diode D5, the light-emitting diode D6 and the light-emitting diode D7 are connected to 6th, 7th and 8th pins of chip U3, respectively, the other ends of the light-emitting diode D5, the light-emitting diode D6 and the light-emitting diode D7 are respectively connected with a resistor R15, a resistor R16 and a resistor R19, and the other ends of the resistor R15, the resistor R16 and the resistor R19 are connected together; the function button circuit includes an interface TP1, an interface TP2, an interface TP3, an interface TP4, an interface TP5, an interface TP6, and a button SW2, wherein the interface TP1, the interface TP2, the interface TP3, the interface TP4, the interface TP5, the interface TP6, and the button SW2 are respectively connected to the 11th, 12th, 13th, 14th, 15th, 16th, and 17th pins of the chip U3, and correspondingly connected with a resistor R13, a resistor R20, a resistor R21, a resistor R22, a resistor R23, a resistor R24 and a resistor R25, the other ends of the resistor R13, the resistor R20, the resistor R21, the resistor R22, the resistor R23, the resistor R24 and the resistor R25 being connected together; the reset circuit includes a resistor R10 and a button SW3, wherein one end of the button SW3 is grounded, and the other end is connected to the 17th pin of the chip U3, one end of the button SW3 connected with the 17th pin of the chip U3 being connected with a resistor R10; the pressure sensor includes a chip U5, wherein a GND pin of the chip U5 is grounded, a VDD pin of the chip U5 is connected to a resistor R17 and a resistor R18, respectively, the other end of the resistor R17 is connected to a 2nd pin of the chip U5, the other end of the resistor R18 is connected to a 3rd pin of the chip U5, and the 2nd pin and the 3rd pin of the chip U5 are respectively connected to 20th and 19th pins of the chip U3; a 1st pin of the program download port is grounded, a 2nd pin of the program download port is connected with a 26th pin of the chip U3, a 3rd pin of the program download port is connected with a 25th pin of the chip U3, and a 4 pin of the program download port is connected to a 3.3V power supply; the depth sensor includes a chip U4, wherein a 3rd pin of the chip U4 is connected to a 43rd pin of the chip U3, a 2nd pin of the chip U4 is grounded, a resistor R14 is connected between the 3rd pin of the chip U4 and the 2nd pin of the chip U4, a 1st pin of the chip U4 is connected to a 42th pin of the chip U3, the 1st pin of the chip U4 is connected with a resistor R11, a SDI pin of the chip U4 is connected to a 40th pin of the chip U3, a SDO pin of the chip U4 is connected to a 41th pin of the chip U3, and a resistor R12 is connected between a VDD pin of the chip U4 and a SDI pin of the chip U4; the 3.3V voltage regulator circuit includes a chip U2, wherein a 5th pin of the chip U2 is respectively connected to the VDD pin and a PS pin of the chip U4, the 5th pin of the chip U2 is also connected to a capacitor C15, the other end of the capacitor C15 is grounded, a VIN pin and a CE pin of the chip U2 are respectively connected to a capacitor C16, the other end of the capacitor C16 and a GND end of the chip U2 are grounded, and one end of the capacitor C16 connected to the chip U2 is also connected to the collector of the transistor Q1; the charge management circuit includes a chip U1, wherein 5th and 3rd pins of the chip U1 are respectively connected to two ends of a capacitor C5 and a capacitor C6, two ends of the capacitor C6 are also connected to a header P1, a 5th pin of the chip U1 is also connected to an emitter of the triode Q1, a 2nd pin of the chip U1 is connected to a resistor R4, the other end of the resistor R4 and a 1st pin of the chip U1 are grounded respectively, a GHRG pin and a STDBY pin of the chip U1 are respectively connected to a light-emitting diode D1 and a light-emitting diode D2, and the other ends of the light-emitting diode D1 and the light-emitting diode D2 are respectively connected with a resistor R2 and a resistor R3; the other ends of the resistor R2 and the resistor R3 are connected together, and then connected to a VCC pin and a CE pin of the chip U1, respectively; one end of a capacitor C3 and one end of a capacitor C4 are grounded, and the other ends thereof is connected to the resistor R2 and the resistor R3; the ends of the resistor R2 connected together with the resistor R3 is further connected with a resistor R1.

### Embodiment 2

The present embodiment differs from Embodiment 1 in that the surface of the rear housing 2 is further connected with a light-filling assembly 4, and the light-filling assembly 4 is located at one side of the photographing window 11;

Further, the light-filling assembly 4 includes a lamp holder 41, an LED board 42, a light-filling seal ring 43 and a lamp head 44, wherein the lamp holder 41 is connected to the rear housing 2, and the lamp holder 41 is engagedly connected with the lamp head 44; an interior of the lamp head 44 is connected with the LED board 42, and the light-filling seal ring 43 is placed between the lamp head 44 and the lamp holder 41, the LED board 42 being signally connected to the control module.

### Embodiment 3

The present embodiment differs from Embodiment 1 in that the surface of the rear housing 2 is further connected with an air suction assembly 5 and a light-filling assembly 4, wherein the air suction assembly 5 is located on one side of the photographing window 11, and the light-filling assembly 4 is located on the other side of the air suction assembly 5.

Further, the method for implementing a phone case for diving according to the present invention comprises steps of:

(I) opening the front housing 3 and the rear housing 2;

(II) turning on the phone Bluetooth for connecting with the control module via the Bluetooth, placing the phone therein, and a display screen of the phone facing the front housing 3;

(III) closing the front housing 3 and the rear housing 2, and tightening by the sealing knob 9;

(IV) rotating the end cap 59 to separate the fixing buckle 51 from the fixing groove 57, then pushing and pulling the end cap 59 to extract the air inside the housing 1;

(V) fixing the end cap 59 to the fixing groove 57 through the fixing buckle 51 after extracting the air, then performing operations by the function button 8.

In the present embodiment, the pressure sensor is model MS5637-02BA03, which is sold by Tyco Electronics (Shanghai) Co., Ltd.; the depth sensor is model MS5803-14BA, which is sold by Tyco Electronics (Shanghai) Co., Ltd.; the power supply 3 is model TP4056, which is sold by NanJing Top PowerASIC Corp.

In summary, in the present invention, an air inside the housing 1 is taken out by the air suction assembly 5, so that the interior of the housing 1 is vacuumed and the waterproof performance is good, and no steam will appear inside the housing 1 so as to make the photographing effect better; the present invention is provided with a function button 8 and a photographing button 12, and is connected with the phone through Bluetooth, so as to facilitate the use; the present invention is provided with a light-filling assembly 4, so that the light may be provided when taking pictures to make the photographing effect better; the present invention is provided with a handle portion 14, and the photographing button 12 is arranged on the handle portion, so as to make the present invention more convenient to use.

Although the embodiments of the present invention have been shown and described, it can be understood that a person skilled in the art can make various changes, modifications, substitutions and variations to the embodiments without departing from the principle and spirit of the present invention; and the scope of the present invention is defined by the attached claims and equivalents thereof.

What is claimed is:

1. A phone case for diving, comprising a housing (1), the housing (1) including a rear housing (2) and a front housing (3), the rear housing (2) being rotatably connected to one side of the front housing (3) and being sealingly connected to the other side, one side of a surface of the rear housing (2) being connected with a photographing window (11), characterized in that the surface of the rear housing (2) is further connected with a air suction assembly (5) and/or a light-filling assembly (4); the air suction assembly (5) is located on one side of the photographing window (11), and the light-filling assembly (4) is located on the other side of the air suction assembly (5); the housing (1) is connected with a function button (8), and an interior of the housing (1) is connected with a control module, wherein the function button (8) and the light-filling assembly (4) are respectively signally connected to the control module, and the control module is connected with the phone by Bluetooth.

2. The phone case for diving according to claim 1, characterized in that the light-filling assembly (4) includes a lamp holder (41), an LED board (42), a light-filling seal ring (43) and a lamp head (44), wherein the lamp holder (41) is connected to the rear housing (2), and the lamp holder (41) is engagedly connected with the lamp head (44); an interior of the lamp head (44) is connected with the LED board (42), and the light-filling seal ring (43) is placed between the lamp head (44) and the lamp holder (41), the LED board (42) being signally connected to the control module.

3. The phone case for diving according to claim 2, characterized in that the air suction assembly (5) includes an air suction rod (52), an air suction head (53), an air suction pipe (54), a sealing cap (55), an one-way air outlet valve (56), an air suction sealing ring (58) and an end cap (59), wherein the air suction pipe (54) is connected to the rear housing (2), and a lower end of the air suction pipe (54) is communicated to an interior of the rear housing (2); the one-way air outlet valve (56) is disposed where the air suction pipe (54) is communicated to the rear housing (2), and its outer side is sealed by the sealing cap (55); an interior of the air suction pipe (54) is slidably connected with the air suction rod (52), one end of the air suction rod (52) located inside the air suction pipe (54) is connected with the air suction head (53), and the other end of the air suction rod (52) is connected with the end cap (59); the air suction sealing ring (58) is disposed between the end cap (59) and the air suction pipe (54); a fixing groove (57) is disposed at one end of the air suction pipe (54) connected with the end cap (59), and the end cap (59) is connected with a fixing buckle (51) matching the fixing groove (57).

4. The phone case for diving according to claim 3, characterized in that the surface of the rear housing (2) is further connected with a sensor (6), and the sensor (6) is located on one side of the air suction assembly (5); the sensor (6) includes a sensor mounting seat (61), a sensor array (62) and a protective cap (63), wherein the sensor mounting seat (61) is connected on the rear housing (2), and an interior of the sensor mounting seat (61) is connected with the sensor array (62); the sensor array (62) includes a pressure sensor and a depth sensor, and the pressure sensor is located on one side of the depth sensor; an end of the sensor mounting seat (61) is connected with the protective cap (63), and the sensor array (62) is signally connected with the control module.

5. The phone case for diving according to claim 4, characterized in that the front housing (3) is connected with a surface cap (7), and both the surface cap (7) and the photographing window (11) are transparent members; the rear housing (2) is provided with a handle portion (14), and the handle portion (14) is located on a side away from the photographing window (11); the function button (8) includes a photographing button (12), the function button (8) is connected on the front housing (3) and located on one side of the surface cop (7); the photographing button (12) is connected on the handle portion (14); one side of the rear housing (2) is rotatably connected to one side of the front housing (3) by a shaft (10), and the other side of the rear housing is sealingly connected to the other side of the front housing by a sealing knob (9).

6. The phone case for diving according to claim 5, characterized in that the control module includes a control chip, a switch circuit, a battery power detection circuit, an LED indicator, a function button circuit, a reset circuit, a program download port, a 3.3V voltage regulator circuit and a charge management circuit, wherein the switch circuit, the battery power detection circuit, the LED indicator, the function button circuit, the reset circuit, and the program download port are respectively connected to the control chip, and the depth sensor and the pressure sensor are also connected to the control chip; the 3.3V voltage regulator circuit is connected to the switch circuit and the depth sensor respectively, and the charge management circuit is connected to the switch circuit.

7. The phone case for diving according to claim 6, characterized in that the control chip includes a chip U3; a VDD terminal of the chip U3 is connected to a capacitor C18 and a capacitor C19, respectively; and the other ends of the capacitor C18 and the capacitor C19 are grounded; a 30th pin of the chip U3 is respectively connected to a capacitor C13 and a inductor L3, and the other end of the inductor L3 is connected with a capacitor C14 and an inductor L4, respectively; the other ends of the capacitor C13 and the capacitor C14 are grounded, and the other end of the inductor L4 is connected to an antenna E1; a 36th pin of the chip U3 is connected to a capacitor C11, and the other end of the capacitor C11 is grounded; the 35th pin of the chip U3 is connected to a capacitor C2, and the 34th pin of the chip U3 is connected to a capacitor C9; the other ends of the capacitor C2 and the capacitor C9 are grounded, and an oscillator X1 is connected between the connection ends where the capacitor C2 is connected to the chip U3 and the capacitor C9 is connected to the chip; the 33th pin of the chip U3 is connected to a capacitor C10, and the 32th pin of the chip U3 is connected to a capacitor C12; the other ends of the capacitor C10 and the capacitor C12 are grounded, and are also connected to the 31th pin of the chip U3; the 47th pin of the chip U3 is connected to an inductor L2, and the other end of the inductor L2 is connected to the inductor L1; the other end of the inductor L1 is respectively connected to a capacitor C1 and a 46th pin of the chip U3, and the other end of the capacitor C1 is grounded and connected to a 45th pin of the chip U3; a 48th pin of the chip U3 is connected to a capacitor C8, and the other end of the capacitor C8 is grounded; a DEC1 pin of the chip U3 is connected to a capacitor C7, and the other end of the capacitor C7 is connected to the capacitor C8.

8. The phone case for diving according to claim 7, characterized in that the switch circuit includes a triode Q1; an emitter and an base of the triode Q1 are respectively connected to the two ends of a resistor R5, and the base of the triode Q1 is also connected to a resistor R7; the other end of the resistor R7 is respectively connected to a collector of a triode Q2 and one end of a diode D3; an emitter of the triode Q2 is grounded, and a base of the triode Q2 is connected to a resistor R9; the other end of the resistor R9 is connected to a 0th pin of the chip U3, and the other end of a diode D3 is respectively connected to a button SW1 and a diode D4; the other end of the button SW1 is grounded, and the other end of the diode D4 is connected to a 1th pin of the chip U3; the battery power detection circuit includes a resistor R6, a resistor R8 and a capacitor C17, wherein one end of the resistor R6 is respectively connected to a resistor R8 and a 5th pin of the chip U3, the other end of the resistor R8 is grounded, and two ends of the resistor R8 are also connected to two ends of the capacitor C17; the LED indicator comprises a light-emitting diode D5, a light-emitting diode D6 and a light-emitting diode D7, wherein the light-emitting diode D5, the light-emitting diode D6 and the light-emitting diode D7 are connected to 6th, 7th and 8th pins of chip U3, respectively, the other ends of the light-emitting diode D5, the light-emitting diode D6 and the light-emitting diode D7 are respectively connected with a resistor R15, a resistor R16 and a resistor R19, and the other ends of the resistor R15, the resistor R16 and the resistor R19 are connected together; the function button circuit includes an interface TP1, an interface TP2, an interface TP3, an interface TP4, an interface TP5, an interface TP6, and a button SW2, wherein the interface TP1, the interface TP2, the interface TP3, the interface TP4, the interface TP5, the interface TP6, and the button SW2 are respectively connected to the 11th, 12th, 13th, 14th, 15th, 16th, and 17th pins of the chip U3, and correspondingly connected with a resistor R13, a resistor R20, a resistor R21, a resistor R22, a resistor R23, a resistor R24 and a resistor R25, the other ends of the resistor R13, the resistor R20, the resistor R21, the resistor R22, the resistor R23, the resistor R24 and the resistor R25 being connected together; the reset circuit includes a resistor R10 and a button SW3, wherein one end of the button SW3 is grounded, and the other end is connected to the 17th pin of the chip U3, one end of the button SW3 connected with the 17th pin of the chip U3 being connected with a resistor R10; the pressure sensor includes a chip U5, wherein a GND pin of the chip U5 is grounded, a VDD pin of the chip U5 is connected to a resistor R17 and a resistor R18, respectively, the other end of the resistor R17 is connected to a 2nd pin of the chip U5, the other end of the resistor R18 is connected to a 3rd pin of the chip U5, and the 2nd pin and the 3rd pin of the chip U5 are respectively connected to 20th and 19th pins of the chip U3; a 1st pin of the program download port is grounded, a 2nd pin of the program download port is connected with a 26th pin of the chip U3, a 3rd pin of the program download port is connected with a 25th pin of the chip U3, and a 4 pin of the program download port is connected to a 3.3V power supply; the depth sensor includes a chip U4, wherein a 3rd pin of the chip U4 is connected to a 43rd pin of the chip U3, a 2nd pin of the chip U4 is grounded, a resistor R14 is connected between the 3rd pin of the chip U4 and the 2nd pin of the chip U4, a 1st pin of the chip U4 is connected to a 42th pin of the chip U3, a SDI pin of the chip U4 is connected to a 40th pin of the chip U3, a SDO pin of the chip U4 is connected to a 41th pin of the chip U3, and a resistor R12 is connected between a VDD pin of the chip U4 and a SDI pin of the chip U4; the 3.3V voltage regulator circuit includes a chip U2, wherein a 5th pin of the chip U2 is respectively connected to the VDD pin and a PS pin of the chip U4, the 5th pin of the chip U2 is also connected to a capacitor C15, the other end of the capacitor C15 is grounded, a VIN pin and a CE pin of the chip U2 are respectively connected to a capacitor C16, the other end of the capacitor C16 and a GND end of the chip U2 are grounded, and one end of the capacitor C16 connected to the chip U2 is also connected to the collector of the transistor Q1; the charge management circuit includes a chip U1, wherein 5th and 3rd pins of the chip U1 are respectively connected to two ends of a capacitor C5 and a capacitor C6, two ends of the capacitor C6 are also connected to a header P1, a 5th pin of the chip U1 is also connected to an emitter of the triode Q1, a 2nd pin of the chip U1 is connected to a resistor R4, the other end of the resistor R4 and a 1st pin of the chip U1 are grounded respectively, a GHRG pin and a STDBY pin of the chip U1 are respectively connected to a light-emitting diode D1 and a light-emitting diode D2, and the other ends of the light-emitting diode D1 and the light-emitting diode D2 are respectively connected with a resistor R2 and a resistor R3; the other ends of the resistor R2 and the resistor R3 are connected together, and then connected to a VCC pin and a CE pin of the chip U1, respectively; one end of a capacitor C3 and one end of a capacitor C4 are grounded, and the other ends thereof is connected to the resistor R2 and the resistor R3; the ends of the resistor R2 connected together with the resistor R3 is further connected with a resistor R1.

9. The method for implementing a phone case for diving according to claim 8, characterized by comprising steps of:
(I) opening the front housing (3) and the rear housing (2);
(II) turning on the phone Bluetooth for connecting with the control module via the Bluetooth, placing the phone therein, and a display screen of the phone facing the front housing (3);
(III) closing the front housing (3) and the rear housing (2), and tightening by the sealing knob (9);
(IV) rotating the end cap (59) to separate the fixing buckle (51) from the fixing groove (57), then pushing and pulling the end cap (59) to extract the air inside the housing (1);
(V) fixing the end cap (59) to the fixing groove (57) through the fixing buckle (51) after extracting the air, then performing operations by the function button (8).

10. The method for implementing a phone case for diving according to claim 9, characterized in that the light-filling assembly (4) includes a lamp holder (41), an LED board (42), a light-filling seal ring (43) and a lamp head (44), wherein the lamp holder (41) is connected to the rear housing (2), and the lamp holder (41) is engagedly connected with the lamp head (44); an interior of the lamp head (44) is connected with the LED board (42), and the light-filling seal ring (43) is placed between the lamp head (44) and the lamp holder (41), the LED board (42) being signally connected to the control module; the air suction assembly (5) includes an air suction rod (52), an air suction head (53), an air suction pipe (54), a sealing cap (55), an one-way air outlet valve (56), an air suction sealing ring (58) and an end cap (59), wherein the air suction pipe (54) is connected to the rear housing (2), and a lower end of the air suction pipe (54) is communicated to an interior of the rear housing (2); the one-way air outlet valve (56) is disposed where the air suction pipe (54) is communicated to the rear housing (2), and its outer side is sealed by the sealing cap (55); an interior of the air suction pipe (54) is slidably connected with the air suction rod (52), one end of the air suction rod (52) located inside the air suction pipe (54) is connected with the air suction head (53), and the other end of the air suction rod (52) is connected with the end cap (59); the air suction sealing ring (58) is disposed between the end cap (59) and the air suction pipe (54); a fixing groove (57) is disposed at one end of the air suction pipe (54) connected with the end cap (59), and the end cap (59) is connected with a fixing buckle (51) matching the fixing groove (57); the surface of the rear housing (2) is further connected with a sensor (6), and the sensor (6) is located on one side of the air suction assembly (5); the sensor (6) includes a sensor mounting seat (61), a sensor array (62) and a protective cap (63), wherein the sensor mounting seat (61) is connected on the rear housing (2), and an interior of the sensor mounting seat (61) is connected with the sensor array (62); the sensor array (62) includes a pressure sensor and a depth sensor, and the pressure sensor is located on one side of the depth sensor; an end of the sensor mounting seat (61) is connected with the protective cap (63), and the sensor array (62) is signally connected with the control module; the front housing (3) is connected with a surface cap (7), and both the surface cap (7) and the photographing window (11) are transparent members; the rear housing (2) is provided with a handle portion (14), and the handle portion (14) is located on a side away from the photographing window (11); the function button (8) includes a photographing button (12), the function button (8) is connected on the front housing (3) and located on one side of the surface cop (7); the photographing button (12) is connected on the handle portion (14); one side of the rear housing (2) is rotatably connected to one side of the front housing (3) by a shaft (10), and the other side of the rear housing is sealingly connected to the other side of the front housing by a sealing knob (9); the control module includes a control chip, a switch circuit, a battery power detection circuit, an LED indicator, a function button circuit, a reset circuit, a program download port, a 3.3V voltage regulator circuit and a charge management circuit, wherein the switch circuit, the battery power detection circuit, the LED indicator, the function button circuit, the reset circuit, and the program download port are respectively connected to the control chip, and the depth sensor and the pressure sensor are also connected to the control chip; the 3.3V voltage regulator circuit is connected to the switch circuit and the depth sensor respectively, and the charge management circuit is connected to the switch circuit; the control chip includes a chip U3; a VDD terminal of the chip U3 is connected to a capacitor C18 and a capacitor C19, respectively; and the other ends of the capacitor C18 and the capacitor C19 are grounded; a 30th pin of the chip U3 is respectively connected to a capacitor C13 and a inductor L3, and the other end of the inductor L3 is connected with a capacitor C14 and an inductor L4, respectively; the other ends of the capacitor C13 and the capacitor C14 are grounded, and the other end of the inductor L4 is connected to an antenna E1; a 36th pin of the chip U3 is connected to a capacitor C11, and the other end of the capacitor C11 is grounded; the 35th pin of the chip U3 is connected to a capacitor C2, and the 34th pin of the chip U3 is connected to a capacitor C9; the other ends of the capacitor C2 and the capacitor C9 are grounded, and an oscillator X1 is connected between the connection ends where the capacitor C2 is connected to the chip U3 and the capacitor C9 is connected to the chip; the 33th pin of the chip U3 is connected to a capacitor C10, and the 32th pin of the chip U3 is connected to a capacitor C12; the other ends of the capacitor C10 and the capacitor C12 are grounded, and are also connected to the 31th pin of the chip U3; the 47th pin of the chip U3 is connected to an inductor L2, and the other end of the inductor L2 is connected to the inductor L1; the other end of the inductor L1 is respectively connected to a capacitor C1 and a 46th pin of the chip U3, and the other end of the capacitor C1 is grounded and connected to a 45th pin of the chip U3; a 48th pin of the chip U3 is connected to a capacitor C8, and the other end of the capacitor C8 is grounded; a DEC1 pin of the chip U3 is connected to a capacitor C7, and the other end of the capacitor C7 is connected to the capacitor C8; the switch circuit includes a triode Q1; an emitter and an base of the triode Q1 are respectively connected to the two ends of a resistor R5, and the base of the triode Q1 is also connected to a resistor R7; the other end of the resistor R7 is respectively connected to a collector of a triode Q2 and one end of a diode D3; an emitter of the triode Q2 is grounded, and a base of the triode Q2 is connected to a resistor R9; the other end of the resistor R9 is connected to a 0th pin of the chip U3, and the other end of a diode D3 is respectively connected to a button SW1 and a diode D4; the other end of the button SW1 is grounded, and the other end of the diode D4 is connected to a 1th pin of the chip U3; the battery power detection circuit includes a resistor R6, a resistor R8 and a capacitor C17, wherein one end of the resistor R6 is respectively connected to a resistor R8 and a 5th pin of the chip U3, the other end of the resistor R8 is grounded, and two ends of the resistor R8 are also connected to two ends of the capacitor C17; the LED indicator comprises a light-emitting diode D5, a light-emitting diode D6 and a light-emitting diode D7, wherein the light-emitting diode D5, the light-emitting diode D6 and the light-emitting diode D7 are connected to 6th, 7th and 8th pins of chip U3, respectively, the other ends of the light-emitting diode D5, the light-emitting diode D6 and the light-emitting diode D7 are respectively connected with a resistor R15, a resistor R16 and a resistor R19, and the other ends of the resistor R15, the resistor R16 and the resistor R19 are connected together; the function button circuit includes an interface TP1, an interface TP2, an interface TP3, an interface TP4, an interface TP5, an interface TP6, and a button SW2, wherein the interface TP1, the interface TP2, the interface TP3, the interface TP4, the interface TP5, the interface TP6, and the button SW2 are respectively connected to the 11th, 12th, 13th, 14th, 15th, 16th, and 17th pins of the chip U3, and correspondingly connected with a resistor R13, a resistor R20, a resistor R21, a resistor R22, a resistor R23, a resistor R24 and a resistor R25, the other ends of the resistor R13, the resistor R20, the resistor R21, the resistor R22, the resistor R23, the resistor R24 and the resistor R25 being connected together; the reset circuit includes a resistor R10 and a button SW3, wherein one end of the button SW3 is grounded, and the other end is connected to the 17th pin of the chip U3, one end of the button SW3 connected with the 17th pin of the chip U3 being connected with a resistor R10; the pressure sensor includes a chip U5, wherein a GND pin of the chip U5 is grounded, a VDD pin of the chip U5 is connected to a resistor R17 and a resistor R18, respectively, the other end of the resistor R17 is connected to a 2nd pin of the chip U5, the other end of the resistor R18 is connected to a 3rd pin of the chip U5, and the 2nd pin and the 3rd pin of the chip U5 are respectively connected to 20th and 19th pins of the chip U3; a 1st pin of the program download port is grounded, a 2nd pin of the program download port is connected with a 26th pin of the chip U3, a 3rd pin of the program download port is connected with a 25th pin of the chip U3, and a 4 pin of the program download port is connected to a 3.3V power supply; the depth sensor includes a chip U4, wherein a 3rd pin of the chip U4 is connected to a 43rd pin of the chip U3, a 2nd pin of the chip U4 is grounded, a resistor R14 is connected between the 3rd pin of the chip U4 and the 2nd pin of the chip U4, a 1st pin of the chip U4 is connected to a 42th pin of the chip U3, a SDI pin of the chip U4 is connected to a 40th pin of the chip U3, a SDO pin of the chip U4 is connected to a 41th pin of the chip U3, and a resistor R12 is connected between a VDD pin of the chip U4 and a SDI pin of the chip U4; the 3.3V voltage regulator circuit includes a chip U2, wherein a 5th pin of the chip U2 is respectively connected to the VDD pin and a PS pin of the chip U4, the 5th pin of the chip U2 is also connected to a capacitor C15, the other end of the capacitor C15 is grounded, a VIN pin and a CE pin of the chip U2 are respectively connected to a capacitor C16, the other end of the capacitor C16 and a GND end of the chip U2 are grounded, and one end of the capacitor C16 connected to the chip U2 is also connected to the collector of the transistor Q1; the charge management circuit includes a chip U1, wherein 5th and 3rd pins of the chip U1 are respectively connected to two ends of a capacitor C5 and a capacitor C6, two ends of the capacitor C6 are also connected to a header P1, a 5th pin of the chip U1 is also connected to an emitter of the triode Q1, a 2nd pin of the chip U1 is connected to a resistor R4, the other end of the resistor R4 and a 1st pin of the chip U1 are grounded respectively, a GHRG pin and a STDBY pin of the chip U1 are respectively connected to a light-emitting diode D1 and a light-emitting diode D2, and the other ends of the light-emitting diode D1 and the light-emitting diode D2 are respectively connected with a resistor R2 and a resistor R3; the other ends of the resistor R2 and the resistor R3 are connected together, and then connected to a VCC pin and a CE pin of the chip U1, respectively; one end of a capacitor C3 and one end of a capacitor C4 are grounded, and the other ends thereof is connected to the resistor R2 and the resistor R3; the ends of the resistor R2 connected together with the resistor R3 is further connected with a resistor R1.
